(19) United States
(12) Patent Application Publication
(10) Pub. No.: US 2024/0126104 A1
(43) Pub. Date: Apr. 18, 2024

(54) VISION AID DEVICE BASED ON ELECTROCHROMIC LAYER, AND VISION AID GLASSES COMPRISING SAME

(71) Applicant: CELLICO INC., Seongnam-si (KR)

(72) Inventors: Lee Woon JANG, Gwangju-si (KR); Eui Don HAN, Seongnam-si (KR); Ho Sung KANG, Paju-si (KR)

(73) Assignee: CELLICO INC., Seongnam-si (KR)

(21) Appl. No.: 18/398,576

(22) Filed: Dec. 28, 2023

Related U.S. Application Data
(63) Continuation of application No. PCT/KR2022/010636, filed on Jul. 20, 2022.

(30) Foreign Application Priority Data
Jul. 28, 2021 (KR) 10-2021-0099002

(51) Int. Cl. G02C 7/10; G02C 11/00; G02F 1/155

(52) U.S. Cl. CPC G02C 7/101; G02C 11/10; G02F 1/155

(57) ABSTRACT

Disclosed are a vision aid device based on an electrochromic layer that maintains a visibility of light input from an outside and improves a resolution of an image projected to the eyes of a wearer, and vision aid glasses including the same.

### CROSS-REFERENCE TO RELATED APPLICATIONS

The present application is a continuation of International Patent Application No. PCT/KR2022/010636, filed on Jul. 20, 2022, which is based upon and claims the benefit of priority to Korean Patent Application No. 10-2021-0099002 filed on Jul. 28, 2021. The disclosures of the above-listed applications are hereby incorporated by reference herein in their entirety.

### BACKGROUND

Embodiments of the present disclosure described herein relate to a vision aid device based on an electrochromic layer, and vision aid glasses including the same.

According to statistics on the visually impaired, the number one cause of blindness around the world is macular degeneration. Macular degeneration is a disease, in which the macula that is a focal point in the eyes is damaged while causing a lesion, the lesion has the characteristics of gradually growing from the center of the eyes to a periphery of the eyes. As a result, a vision loss occurs from the center of the field of view to the periphery of the field of view.

Recently, various virtual reality and augmented reality-based vision aid devices have been developed for patients with macular degeneration. These vision aid devices include VR-based vision aid devices and AR-based vision aid devices.

Unlike the VR-based vision aid devices that block the fields of view of patients with macular degeneration, the AR-based vision aid devices do not block the fields of view of patients with macular degeneration, and project images of the vision loss area of patients with macular degeneration to the eyes of the patients.

In the AR-based vision aid device, an image processing device processes objects sensed by a camera, and projects images onto lenses. In the conventional AR-based vision aid device, when an illuminance of an image selected by the image processing device is low or an illuminance of light input from an outside is very high, a resolution of the image projected onto the field of view of the patient with macular degeneration is degraded.

### SUMMARY

Embodiments of the present disclosure provide a vision aid device based on an electrochromic layer that maintains a visibility of light input from an outside and improves a resolution of an image projected to the eyes of a wearer, and vision aid glasses including the same.

The technical problems to be solved by the present disclosure are not limited to the aforementioned problems, and any other technical problems not mentioned herein will be clearly understood from the following description by those skilled in the art to which the present disclosure pertains.

An electrochromic module according to an embodiment of the present disclosure includes a first transparent electrode layer, a second transparent electrode layer laminated on the first transparent electrode layer and that has a different polarity from that of the first electrode layer, a transparent insulating layer provided between the first transparent electrode layer and the second transparent electrode layer and that insulates the first transparent electrode layer and the second transparent electrode layer, and at least one electrochromic layer provided in a specific pattern on the transparent insulating layer and that is changed to be transparent or opaque by an electric signal applied between the first transparent electrode layer and the second transparent electrode layer, and when the electric signal is applied between the first transparent electrode layer and the second transparent electrode layer, the electrochromic layer is discolored to be opaque whereby a transmittance of an external image and a reflectivity of a specific image are relatively adjusted.

Furthermore, the transmittance and the reflectivity may be relatively adjusted depending on a disposition shape of the specific pattern.

Furthermore, the specific pattern may have any one of a circular, oval, polygonal, or striped cross-sectional shape.

Furthermore, the electrochromic layer may have patterns of the same cross-sectional shape, which are spaced apart from each other in series and parallel at intervals.

Furthermore, a planar area of the electrochromic layer may be smaller than a planar area of the transparent insulating layer.

An electrochromic module according to another embodiment of the present disclosure includes a first transparent electrode layer, a second transparent electrode layer laminated on the first transparent electrode layer and that has a different polarity from that of the first transparent electrode layer, an electrochromic layer provided between the first transparent electrode layer and the second transparent electrode layer and that is changed to be transparent or opaque depending on an electric signal applied between the first transparent electrode layer and the second transparent electrode layer, and a reflection part provided on an outer surface of any one of the first transparent electrode layer or the second transparent electrode layer to block light input from an outside, and that reflects a specific image projected to the electrochromic layer on an outer surface of the other of the first transparent electrode layer or the second transparent electrode layer.

Furthermore, the reflection part may be formed to have a specific pattern to secure a visibility through the reflection part.

Furthermore, the pattern of the reflection part may have any one of a circular, oval, polygonal, or striped cross-sectional shape.

Furthermore, the reflection part may have patterns of the same cross-sectional shape, which are spaced apart from each other in series and parallel at intervals.

According to an aspect of the present disclosure, a vision aid device based on an electrochromic layer includes a first transparent electrode layer, a second transparent electrode layer laminated on the first transparent electrode layer, and that has a different polarity from that of the first transparent electrode layer, a transparent insulating layer provided between the first transparent electrode layer and the second transparent electrode layer, and that insulates the first transparent electrode layer and the second transparent electrode layer, and an electrochromic module provided on the transparent insulating layer in a specific pattern, and that has one or more electrochromic layer being changed to be transparent or opaque by an electric signal applied between the first transparent electrode layer and the second transparent electrode layer, the vision aid device further includes a lens part including a first lens and a second lens, which are joined to each other while the electrochromic module being interposed therebetween, and the electrochromic layer is discolored to be opaque when the electric signal is applied between the first transparent electrode layer and the second transparent electrode layer of the electrochromic module whereby a transmittance of an external image and a reflectivity of a specific image are adjusted relatively.

Furthermore, the transmittance and the reflectivity may be adjusted relatively depending on a disposition shape of the specific pattern.

Furthermore, the first lens and the second lens may be coupled to each other to be convexo-concave by forming recesses and protrusions having inclined surfaces, on facing surfaces thereof, and the electrochromic module may be disposed on the inclined surfaces of any one of the first lens and the second lens.

Furthermore, the inclined surfaces of the first lens and the second lens may be formed to be inclined with respect to a projection angle of the specific image projected to the electrochromic layer.

Furthermore, the vision aid device may further include an adjustment part that adjusts a supply amount of the electric signal, and the adjustment part may adjust the transmittance and the reflectivity depending on an intensity of the electric signal.

According to another aspect of the present disclosure, a vision aid device based on an electrochromic layer includes a first transparent electrode layer, a second transparent electrode layer laminated on the first transparent electrode layer, and that has a different polarity from that of the first transparent electrode layer, an electrochromic layer provided between the first transparent electrode layer and the second transparent electrode layer, and that is changed to be transparent or opaque by an electric signal applied between the first transparent electrode layer and the second transparent electrode layer, and an electrochromic module provided on an outer surface of any one of the first transparent electrode layer and the second transparent electrode layer, and including a reflection part that shields light input from an outside and that reflects a specific image projected to the electrochromic layer to an outer surface of the other of the first transparent electrode layer and the second transparent electrode layer, and the vision aid device further may include a first lens and a second lens joined to each other while the electrochromic module being interposed therebetween.

Furthermore, the first lens and the second lens may be coupled to each other to be convexo-concave by forming recesses and protrusions having inclined surfaces, on facing surfaces thereof, and the electrochromic module may be disposed on the inclined surfaces of any one of the first lens and the second lens.

Furthermore, the inclined surfaces of the first lens and the second lens may be formed to be inclined with respect to a projection angle of the specific image projected to the electrochromic layer.

According to an aspect of the present disclosure, vision aid glasses include the vision aid device based on an electrochromic layer, glasses, in which a vision aid device based on an electrochromic layer is provided in one area of each thereof, and that protects the eyes of a wearer, and a frame supporting the glasses and having leg parts spanning the ears of the wearer.

Furthermore, the vision aid glasses may further include a camera module that photographs a surrounding of the wearer in a specific image, and a control module that transmits the specific image of the camera, which received from the camera, to the electrochromic module.

Furthermore, the control module reads a vision loss area of the wearer, select, among specific images received from the camera module, a specific image corresponding to the vision loss area of the wearer, and transmit the selected specific image to the electrochromic module.

Furthermore, the control module may be provided in the leg parts.

Other detailed items of the present disclosure may be included in the detailed description and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic view illustrating vision aid glasses according to an embodiment of the present disclosure;

FIG. 2 is a conceptual view illustrating vision aid glasses according to an embodiment of the present disclosure;

FIG. 3 is a perspective view illustrating a vision aid device based on an electrochromic layer according to a first embodiment of the present disclosure;

FIG. 4 is an exploded perspective view illustrating a vision aid device based on an electrochromic layer according to a first embodiment of the present disclosure;

FIG. 5 is a cross-sectional view illustrating an electrochromic module provided in a vision aid device based on an electrochromic layer according to a first embodiment of the present disclosure;

FIGS. 6A, 6B, 6C, 6D, and 6E are perspective views illustrating various pattern shapes of an electrochromic layer of an electrochromic module provided in a vision aid device based on an electrochromic layer according to the first embodiment of the present disclosure;

FIGS. 7A to 8B are conceptual views illustrating an operation process of vision aid glasses including a vision aid device based on an electrochromic layer according to a first embodiment of the present disclosure;

FIG. 9 is a perspective view illustrating a vision aid device based on an electrochromic layer according to a second embodiment of the present disclosure;

FIG. 10 is a cross-sectional view illustrating a vision aid device based on an electrochromic layer according to a second embodiment of the present disclosure;

FIG. 11 is a perspective view illustrating a vision aid device based on an electrochromic layer according to a third embodiment of the present disclosure;

FIG. 12 is a cross-sectional view illustrating a vision aid device based on an electrochromic layer according to a third embodiment of the present disclosure; and

FIGS. 13A to 14B are conceptual views illustrating an operation process of vision aid glasses including a vision aid device based on an electrochromic layer according to second and third embodiments of the present disclosure.

### DETAILED DESCRIPTION

The advantages and features of the present disclosure, and a method for achieving them will become clear with reference to the embodiments that will be described in detail together with the accompanying drawings. However, the present disclosure is not limited by the embodiments disclosed hereinafter but may be implemented in various different forms, and the embodiments are provided simply to make the disclosure of the present disclosure complete and inform an ordinary person in the art of the scope of the present disclosure, and the disclosure is only defined by the scope of the claims.

The terms used in the specification is for describing the embodiments, and is not intended to limit the present disclosure. A singular expression includes a plural expression unless an exemption is particularly described in the specification. The expression “comprises” and/or “comprising” used in the specification does not exclude presence or addition of one or more other components, in addition to the mentioned components. throughout the specification, the same reference numerals denote the same components, and the term “and/or” includes one or more combinations of the mentioned components. Although “first”, “second”, or the like is used to describe various components, it is apparent that the components are not limited by the terns. The terms are used simply to distinguish one component from another component. Accordingly, it is apparent that a first component mentioned hereinafter may be a second component in the technical spirit of the present disclosure.

Unless otherwise defined, all terms (including technical and scientific terms) used herein have the same meaning as commonly understood by those skilled in the art, to which the present disclosure pertains. Furthermore, the terms defined in commonly used dictionaries should not be interpreted in an idealized or overly formal sense unless expressly so defined herein.

Prior to describing the present disclosure, in various embodiments, components having the same configuration are typically described in a first embodiment by using the same reference numerals, and in other embodiments, components having different configurations from those of the first embodiment will be described.

Hereinafter, vision aid glasses according to an embodiment of the present disclosure will be described.

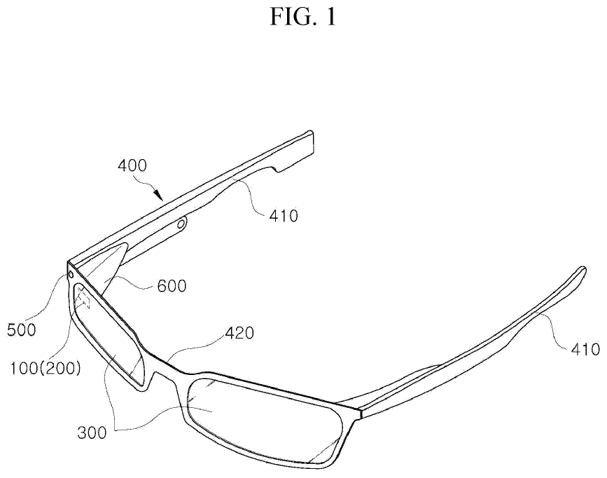

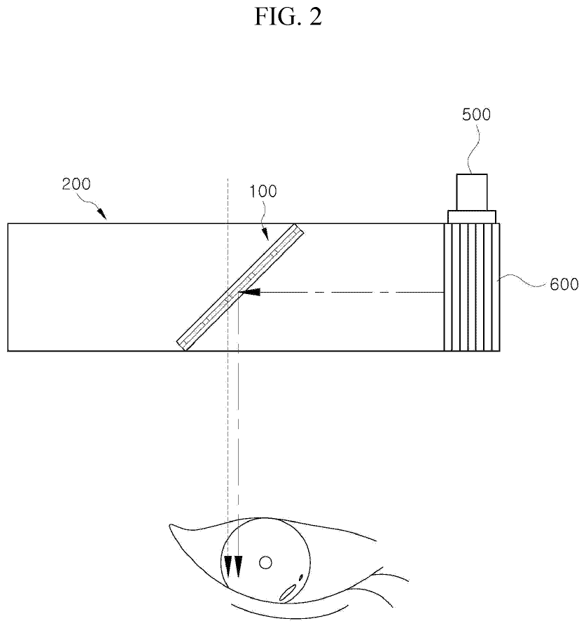

FIG. 1 is a schematic view illustrating vision aid glasses according to an embodiment of the present disclosure, and FIG. 2 is a conceptual view illustrating the vision aid glasses according to an embodiment of the present disclosure.

As illustrated in FIGS. 1 and 2, the vision aid glasses according to an embodiment of the present disclosure include vision aid devices, glasses 300, a frame 400, a camera module 500, and a control module 600.

The vision aid device functions to project a specific image corresponding to a vision loss area of a wearer, which is received from the control module 600, to the eyes of the wearer, and detailed items will be described later.

The vision aid device may be provided with an electrochromic module 100, and when an electric signal is applied, the electrochromic modules 100 function to reflect a specific image that is received from the control module 600 and project it to the eyes of a wearer.

As an example, the electrochromic modules 100 may be embedded in lens parts 200 that are provided on a front side or a rear side of the glasses 300 at an interval.

As another example, the electrochromic modules 100 may be embedded in the glasses 300 together with the lens parts 200.

The vision aid device may be provided in one area of the glasses 300, and function to protect the eyes of the wearer. A pair of glasses 300 are provided, and may protect both eyes of the wearer. Furthermore, the wearer may view an external image that enters a field of view through the glasses 300.

The frame 400 has leg parts 410 that support the glasses and span the ears of the wearer. Specifically, an accommodation space for accommodating the glasses 300 and a nose bridge member 420 that spans the bridge of the nose of the wearer may be provided on a front surface of the frame 400, and the leg parts 410 that span the ears of the wearer may be provided on a side surface of the frame 400.

The camera module 500 functions to capture specific images of the wearer's surroundings. Specifically, the camera module 500 may function to capture a gaze direction of the wearer as a specific image. In this way, the specific image captured by the camera module 500 is transmitted to the control module 600.

The control module 600 serves to transmit a specific image of the camera, which is received from the camera module 500, to the electrochromic module 100. Specifically, the control module 600 may read a vision loss area of the wearer, select, among the images received from the camera module 500, a specific image corresponding to the vision loss area of the wearer, and may transmit the selected specific image to the electrochromic module 100. This control module 600 may be a microcomputer or a server.

The control module 600 may be provided on the leg parts 410 to improve a weight balance of the frame 400. In other words, a front portion of the frame 400 that accommodates the glasses 300 is relatively heavier than a lateral portion that has the leg parts 410. Accordingly, when the control module 600 is installed in the leg parts 410 that are rear portions of the frame 400, a weight that is biased on the front portion of the frame 400 may be compensated for by the lateral portion of the frame 400 whereby the weight balance of the frame 400 may be improved.

Accordingly, in vision aid glasses according to an embodiment of the present disclosure, after the camera module 500 acquires an image of a gaze direction of the wearer, and after, among specific images acquired by the camera module 500, a specific image of the vision loss area of the wearer is selected by the camera module 500, the specific image transmitted by the control module 600 may be reflected by the electrochromic module 100 and may be projected to the eyes of the wearer.

Hereinafter, a vision aid device based on an electrochromic layer according to a first embodiment of the present disclosure will be described.

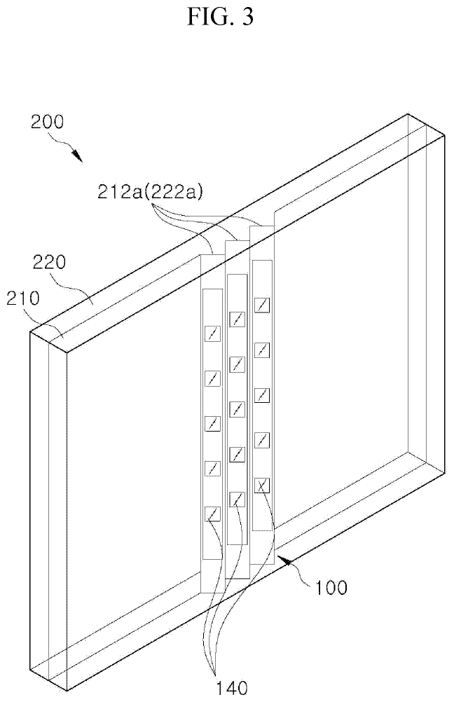

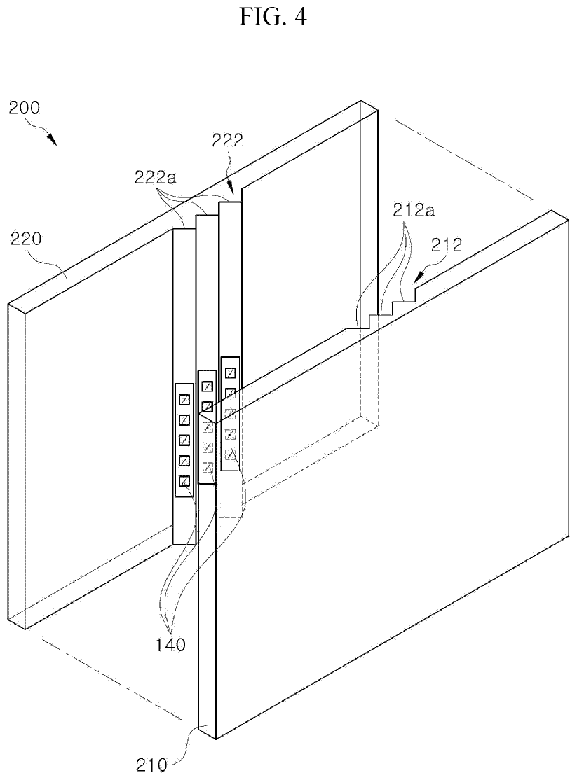

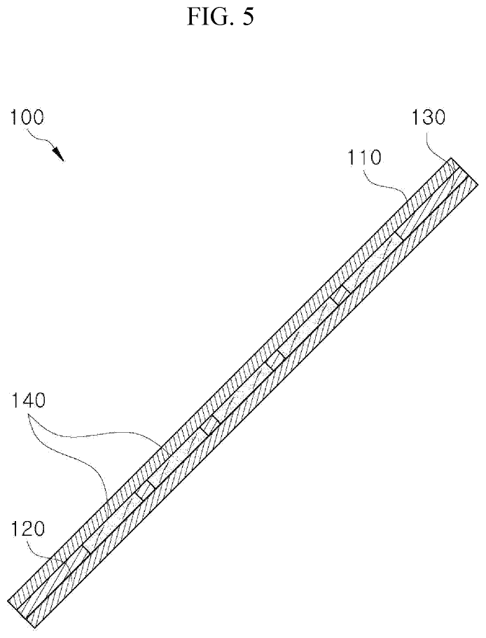

FIG. 3 is a perspective view illustrating the vision aid device based on an electrochromic layer according to the first embodiment of the present disclosure, FIG. 4 is an exploded perspective view illustrating the vision aid device based on an electrochromic layer according to the first embodiment of the present disclosure, and FIG. 5 is a cross-sectional view illustrating the electrochromic module 100 provided in the vision aid device based on an electrochromic layer according to the first embodiment of the present disclosure.

As illustrated in FIGS. 3 to 5, the vision aid device based on an electrochromic layer according to the first embodiment of the present disclosure may include the electrochromic modules 100 and the lens parts 200.

The electrochromic module 100 functions to reflect a specific image when an electric signal is applied. Here, the specific image may be a specific image corresponding to a vision loss area of the wearer, which is received from the control module 600.

The electrochromic module 100 may include a first transparent electrode layer 110, a second transparent electrode layer 120, a transparent insulating layer 130, and an electrochromic layer 140.

The first transparent electrode layer 110 and the second transparent electrode layer 120 are laminated on each other, and have different polarities. For example, the first transparent electrode layer 110 may have a (+) polarity, and the second transparent electrode layer 120 may have a (−) polarity.

Conductive ink is printed on surfaces of the first transparent electrode layer 110 and the second transparent electrode layer 120, and when electric power is supplied, an electric signal is applied between the first transparent electrode layer 110 and the second transparent electrode layer 120.

The materials of the first transparent electrode layer 110 and the second transparent electrode layer 120 are not particularly limited, but may include fluorine tin oxide (FTO), indium in oxide (ITO), graphene, NiO, SnO2, TiO2, Ag, Al, Ti, and Ni.

The transparent electrode layer is provided between the first transparent electrode layer 110 and the second transparent electrode layer 120, and functions to insulate the first transparent electrode layer 110 and the second transparent electrode layer 120. The electrochromic layer 140, which will be described later, may be formed to pass through the transparent electrode layer.

The electrochromic layer 140 is provided in a specific pattern on the transparent insulating layer 130 and may be changed to be transparent or opaque by an electric signal applied between the first transparent electrode layer 110 and the second transparent electrode layer 120. For example, the electrochromic layer 140 includes an electrochromic material, and may be oxidized or reduced to a size depending on a concentration of ions introduced according to an electric signal to be changed to be opaque while a transparency thereof is changed.

Accordingly, when an electric signal is applied between the first transparent electrode layer 110 and the second transparent electrode layer 120, the electrochromic layer 140 is discolored to be opaque whereby a transmittance of an external image and a reflectivity of a specific image may be relatively adjusted. Here, the external image is visible in a field of view of the wearer, and the specific image may be a specific image corresponding to the vision loss area of the wearer, which is transmitted by the control module 600.

For example, the transmittance of the external image and the reflectivity of the specific image of the electrochromic module 100 may be relatively adjusted depending on a disposition shape of a specific pattern of the electrochromic layer 140.

For example, as a plane area of the electrochromic layer 140 in the transparent insulating layer 130 increases, the reflectivity of the specific image reflected on the electrochromic layer 140 may increase, and the transmittance of the external image transmitted through the transparent insulating layer 130 may decrease.

In addition, as the plane area of the electrochromic layer 140 in the transparent insulating layer 130 decreases, the reflectivity of the specific image reflected on the electrochromic layer 140 may decrease, and the transmittance of the external image transmitted through the transparent insulating layer 130 may increase.

As another example, the transmittance of the external image and the reflectivity of the specific image of the electrochromic module 100 may be adjusted by the adjustment part that adjusts the supply amount of the electric signal applied to the first transparent electrode layer 110 and the second transparent electrode layer 120.

The adjustment part may adjust the transmittance of the external image and the reflectivity of the specific image of the electrochromic module 100 depending on an intensity of the electric signal.

For example, as the supply amount of the electric signal supplied by the adjustment part increases, the reflectivity of the specific image of the electrochromic layer 140 may increase.

Furthermore, as the supply amount of the electric signal supplied by the adjustment part decreases, the reflectivity of the specific image of the electrochromic layer 140 may decrease.

Meanwhile, the electrochromic layer 140 may be discolored to be black, brown, green, or silver, and more preferably, may be discolored to be silver.

Furthermore, when no electric signal is applied between the first transparent electrode layer 110 and the second transparent electrode layer 120, the electrochromic layer 140 may be discolored to be transparent and may transmit the specific image.

The material of the electrochromic layer 140 is not particularly limited, but may include WO3, Ion Gel, or the like.

The plane area of the electrochromic layer 140 may be relatively smaller than the plane area of the transparent insulating layer 130. Accordingly, when an electric signal is applied to the electrochromic layer 140, the electrochromic layer 140 is discolored to be opaque and reflects the specific image, and when a field of view for the external image is secured through the transparent insulating layer 130, an area, in which the field of view of the wearer is blocked by the electrochromic layer 140 is relatively small, but an area, in which the field of view of the wearer is secured through the transparent insulating layer 130, may be relatively wide.

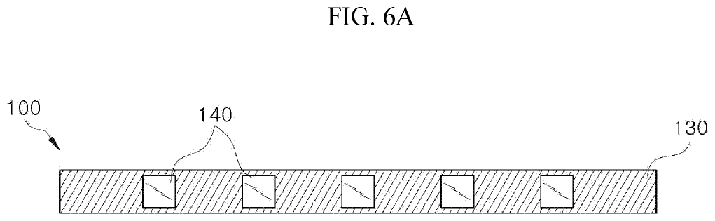

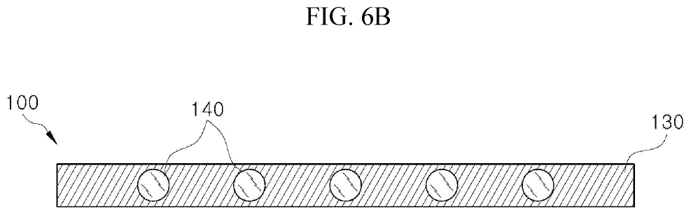

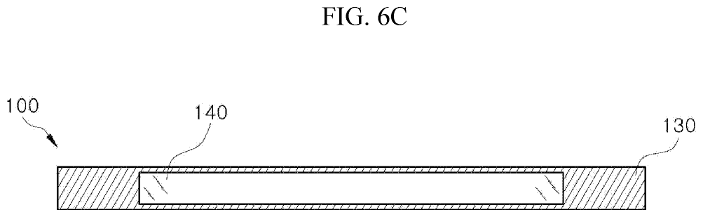

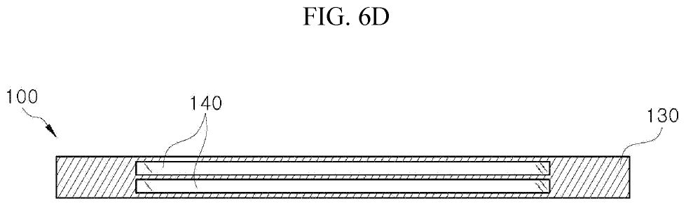

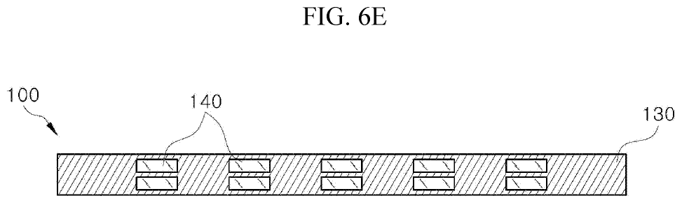

FIGS. 6A, 6B, 6C, 6D, and 6E are perspective views illustrating various pattern shapes of the electrochromic layer 140 of the electrochromic module 100, which are provided in the vision aid device based on an electrochromic layer according to the first embodiment of the present disclosure.

As illustrated in FIGS. 6A to 6E, the pattern of the electrochromic layer 140 may have a cross-sectional shape of any one of circular, oval, polygonal, and stripe shapes. Then, the electrochromic layer 140 may have patterns of the same cross-sectional shape, which are disposed in series and parallel at intervals.

Referring to FIG. 6A, square patterns may be disposed in the electrochromic layer 140 in series at intervals.

Referring to FIG. 6B, circular or oval patterns may be disposed in the electrochromic layer 140 in series at intervals.

Referring to FIG. 6C, the electrochromic layer 140 may be provided in a square pattern, that is, a stripe pattern having a long length in a lengthwise direction.

Referring to FIG. 6D, the electrochromic layer 140 may be disposed in a pair of square patterns having layers. Then, the square pattern may have a long length in the lengthwise direction.

Referring to FIG. 6E, the electrochromic layer 140 may be formed in a pair of square patterns having layers, which are spaced apart from each other in series.

Meanwhile, referring back to FIGS. 3 and 4, the lens part 200 may have a first lens 210 and a second lens 220, which are joined to each other while the electrochromic module 100 being interposed therebetween.

The first lens 210 and the second lens 220 define recesses 212 and protrusions 222 having inclined surfaces 212a and 222a on facing surfaces thereof to be coupled to each other convexo-concavely, and the electrochromic modules 100 may be disposed on the inclined surfaces 212a and 222a of the second lens 220. However, although the drawing illustrates an example, in which the electrochromic module 100 is disposed on the inclined surface 222a of the second lens 220, but the electrochromic module 100 may be disposed on the inclined surface 212a of the first lens 210.

That is, the inclined surfaces 212a and 222a of the first lens 210 and the second lens may be formed to be inclined with respect to the projection angle of the specific image that is projected onto the electrochromic layer 140. Here, the inclined surfaces 212a and 222a of the first lens 210 and the second lens 220 may be formed to be inclined at 40 to 50 degrees with respect to the projection angle of the specific image projected to the electrochromic layer 140, and more preferably, may be formed to be inclined at 45 degrees. Accordingly, the electrochromic module 100 disposed on the inclined surface 222a of the second lens 220 may be disposed to be inclined at 45 degrees with respect to the projection angle of the specific image projected onto the electrochromic layer 140.

As a result, when an electric signal is applied to the electrochromic layer 140, and the electrochromic layer 140 is discolored to be opaque and reflects the specific image, the reflectivity of the specific image in the electrochromic layer 140 may be improved, and noise may be prevented from occurring in the specific image reflected from the electrochromic layer 140.

Hereinafter, a process of operating the vision aid glasses including the vision aid device based on an electrochromic layer according to the first embodiment of the present disclosure will be described.

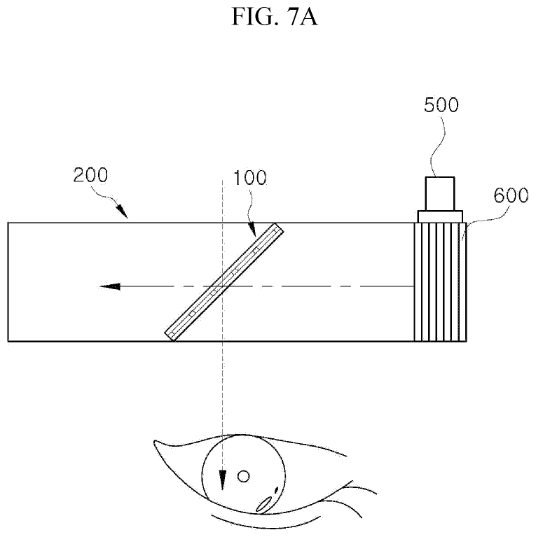

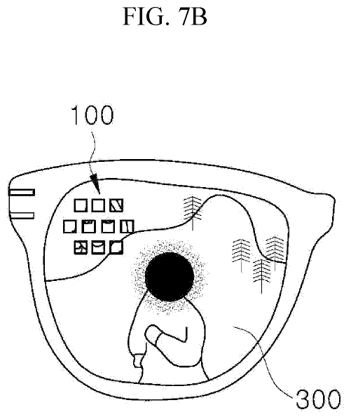

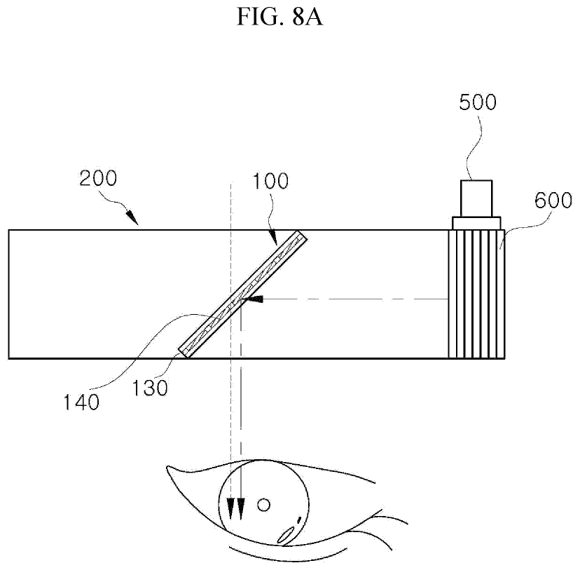

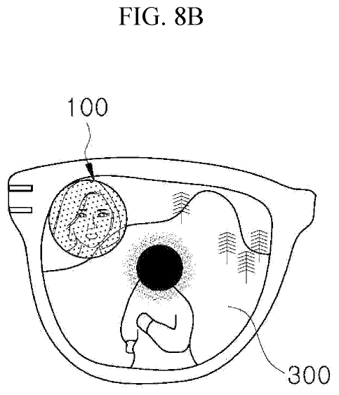

FIGS. 7A to 8B are conceptual views illustrating the process of operating the vision aid glasses including a vision aid device based on an electrochromic layer according to the first embodiment of the present disclosure.

As illustrated in FIGS. 7A and 7B, when no electric power is supplied to the electrochromic module 100, the electrochromic layer 140 of the electrochromic module 100 maintains a transparent state because an electric signal is not transmitted to the first transparent electrode layer 110 and the second transparent electrode layer 120 of the electrochromic module 100. The electrochromic layer 140 in the transparent state does not block the field of view of the wearer. Accordingly, the wearer may view the external image through the electrochromic layer 140.

Then, when the specific image is supplied from the control module 600 to the electrochromic layer 140 in the transparent state, the specific image is not projected to the wearer because the specific image transmits the electrochromic layer 140 in the transparent state.

As illustrated in FIGS. 8A to 8B, when the electric power is supplied to the electrochromic module 100, the electrochromic layer 140 is discolored to an opaque state because an electric signal is transmitted to the first transparent electrode layer 110 and the second transparent electrode layer 120 of the electrochromic module 100. Accordingly, the wearer cannot view the external image through the electrochromic layer 140, but may view the external image through the transparent insulating layer 130.

Then, when the specific image is supplied from the control module 600 to the electrochromic layer 140 in an opaque state, the specific image is reflected by the electrochromic layer 140 in the opaque state and thus, the specific image is projected to the wearer.

The electrochromic layer 140 in the opaque state blocks the field of view of the wearer. However, in the embodiment, the electrochromic layer 140 is provided in a specific pattern, and thus as the field of view of the wearer may be secured through the transparent insulating layer 130 between the electrochromic layers 140 whereby the wearer may view an external image even when the electrochromic layer 140 is in the opaque state.

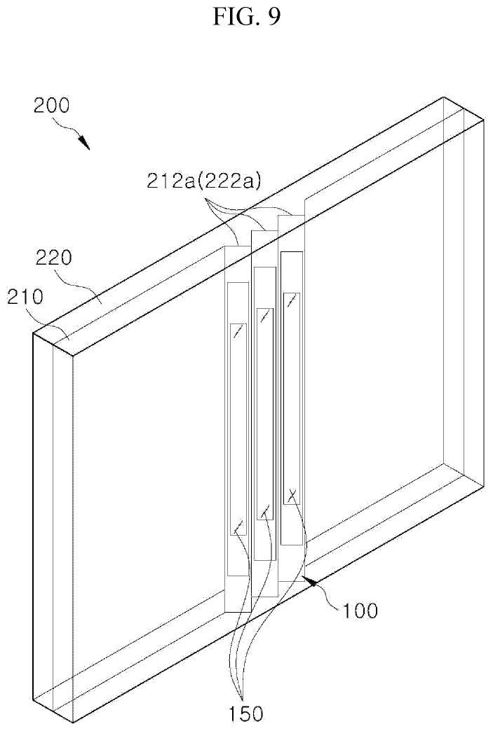

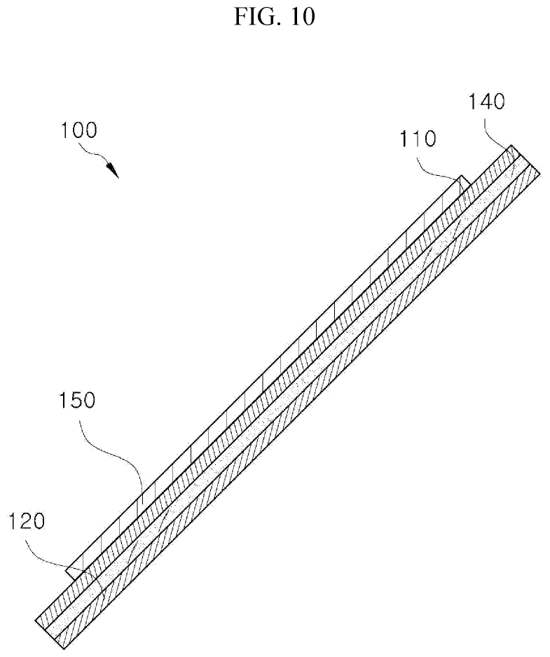

FIG. 9 is a perspective view illustrating a vision aid device based on an electrochromic layer according to a second embodiment of the present disclosure, and FIG. 10 is a cross-sectional view illustrating the vision aid device based on an electrochromic layer according to the second embodiment of the present disclosure.

As illustrated in FIGS. 9 and 10, unlike the first embodiment, the vision aid device based on an electrochromic layer according to the second embodiment of the present disclosure may exclude the transparent insulating layer 130 of the first embodiment, only the electrochromic layer 140 may be provided between the first transparent electrode layer 110 and the second transparent electrode layer 120, and a reflection part 150 may be provided on an outer surface of any one of the first transparent electrode layer 110 or the second transparent electrode layer 120.

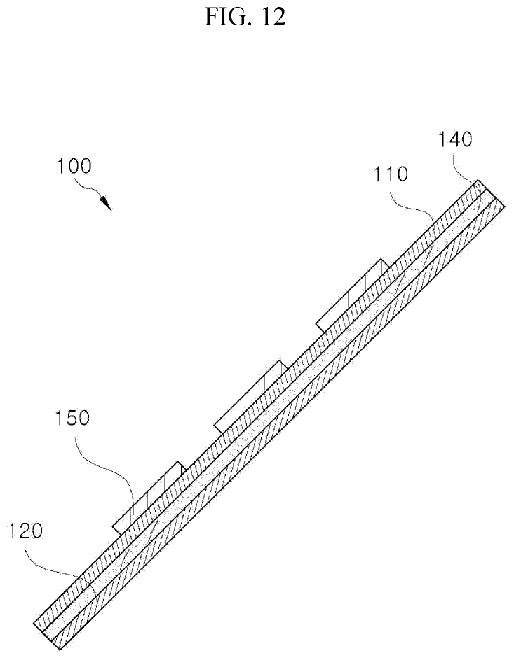

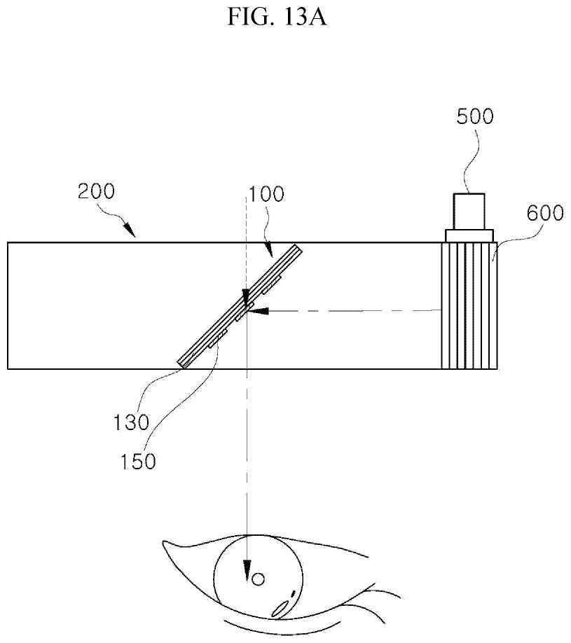

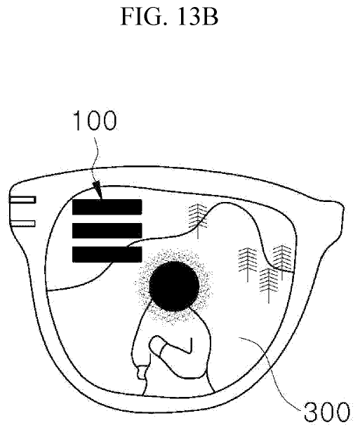

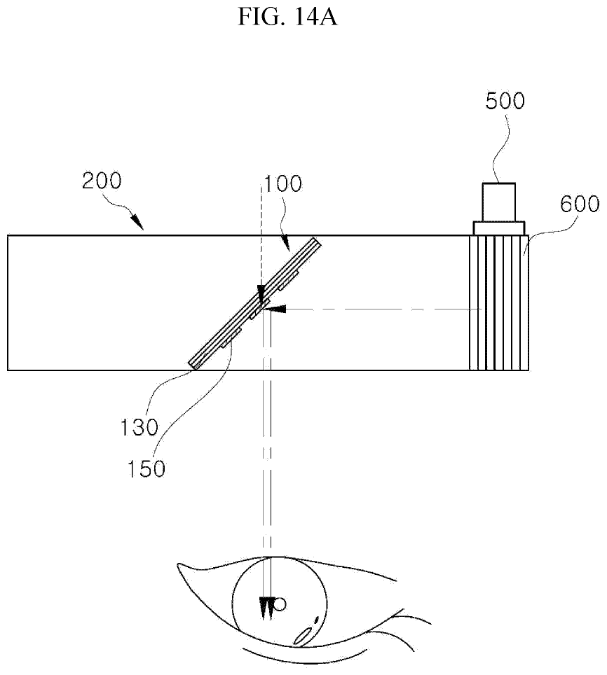

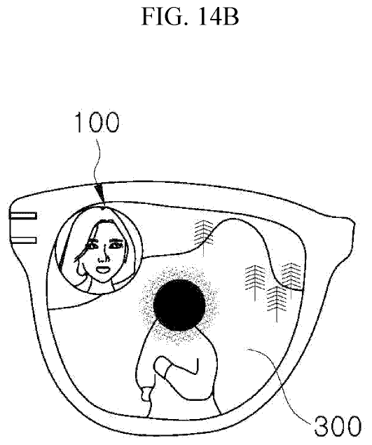

For example, FIGS. 10 and 12 illustrate an example, in which the reflection part 150 is provided on an outer surface of the first transparent electrode layer 110, and FIGS. 13A to 14B illustrate an example, in which the reflection part 150 is provided on an outer surface of the second transparent electrode layer 120.

The reflection part 150 may be provided on an outer surface of any one of the first transparent electrode layer 110 or the second transparent electrode layer 120, may block light that is input from an outside, and may reflect the specific image projected onto the electrochromic layer 140 by the other of the first transparent electrode layer 110 and the second transparent electrode layer 120, and may project it to the eyes of the wearer.

Then, because the reflection part 150 shields light that is input from an outside and reflects the specific image, a reflectivity of the specific image may be higher than that of the electrochromic layer 140 in the opaque state. Accordingly, a resolution of the specific image that is reflected by the reflection part 150 and projected to the eyes of the wearer may be better than a resolution of the specific image that is reflected by the opaque electrochromic layer 140 and projected to the eyes of the wearer.

However, because the reflection part 150 not only shields the light input from the outside, but also blocks the field of view of the wearer, it is preferable that a specific pattern for securing the field of view is formed through the reflection part 150.

Here, the pattern of the reflection part 150 may have a cross-sectional shape of any one of circular, oval, and polygonal shapes. Then, the reflection part 150 may have patterns of the same cross-sectional shape disposed in series and parallel at intervals.

For example, referring to FIG. 10, the reflection part 150 may be formed in a rectangular pattern with a long length in a lengthwise direction.

Although not illustrated in the drawing, the reflection part 150 may be provided on both the outer surface of the first transparent electrode layer 110 and the outer surface of the second transparent electrode layer 120.

In the embodiment, when the reflection part 150 reflects the specific image and projects it to the eyes of the wearer, the electrochromic layer 140 in the opaque state may reduce a surrounding contrast of the reflection part 150, and thus, the specific image projected to the eyes of the wearer may be improved

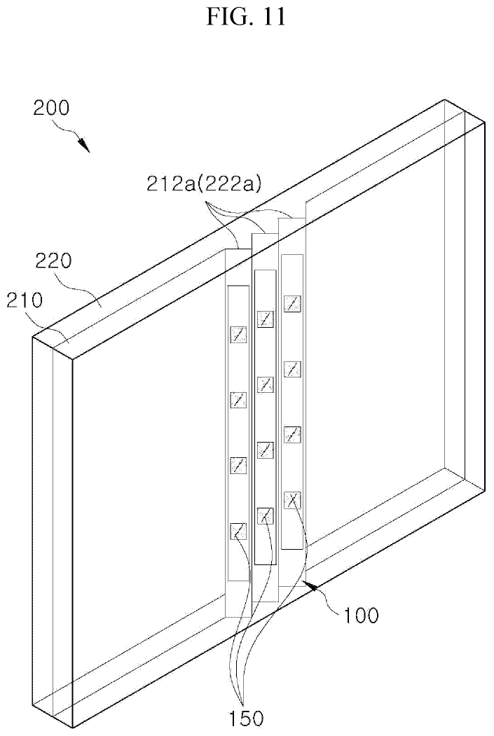

FIG. 11 is a perspective view illustrating a vision aid device based on an electrochromic layer according to a third embodiment of the present disclosure, and FIG. 12 is a cross-sectional view illustrating the vision aid device based on an electrochromic layer according to the third embodiment of the present disclosure.

As illustrated in FIGS. 11 and 12, the vision aid device based on an electrochromic layer according to the third embodiment of the present disclosure is different from that in the second embodiment, and the reflection part 150 has square patterns that are spaced apart from each other in series.

Hereinafter, a process of operating the vision aid glasses including a vision aid device based on an electrochromic layer according to the second embodiment of the present disclosure will be described.

FIGS. 13A to 14B are conceptual views illustrating the process of operating the vision aid glasses including the vision aid device based on an electrochromic layer according to the second embodiment of the present disclosure.

As illustrated in FIGS. 13A and 13B, when no electric power is supplied to the electrochromic module 100, the electrochromic layer 140 of the electrochromic module 100 maintains a transparent state. The electrochromic layer 140 in this transparent state does not block the field of view of the wearer. However, the reflection part 150 blocks the field of view of the wearer.

Then, when the specific image is supplied from the control module 600 to the transparent electrochromic layer 140, the specific image passes through the transparent electrochromic layer 140, but is reflected by the reflection part 150 and thus, the specific image is projected to the wearer.

As illustrated in FIGS. 14A and 14B, when electric power is supplied to the electrochromic module 100, an electric signal is applied to the first transparent electrode layer 110 and the second transparent electrode layer 120 of the electrochromic module 100, and thus, the electrochromic layer 140 is discolored to an opaque state.

Then, when the specific image is supplied from the control module 600 to the electrochromic layer 140 in the opaque state, the specific image is reflected by the electrochromic layer 140 in the opaque state and the reflection part 150 at the same time, and thus, the image is projected to the wearer.

Accordingly, in the embodiment, because the specific image is reflected by the electrochromic layer 140 in the opaque state and the reflection part 150 at the same time and is projected to the wearer, a resolution of the specific image projected to the wearer may be improved.

According to the present disclosure, the vision aid device based on an electrochromic layer according to an embodiment of the present disclosure and the vision aid glasses including the same may maintain a visibility of the light input from the outside and may improve the resolution of the image projected to the eyes of the wearer.

The effects of the present disclosure are not limited to the above-mentioned effects, and other effects that are not mentioned may be clearly understood by those skilled in the art from the description below.

Until now, the embodiments of the present disclosure have been described with reference to the accompanying drawings, but it may be understood that an ordinary person in the art, to which the present disclosure pertains, may carry out the present disclosure in another specific form while not changing the technical spirit or the essential features. Therefore, it should be understood that the embodiments described above are all illustrative, and not restrictive.

What is claimed is:

1. A vision aid device based on an electrochromic layer, the vision aid device comprising:
a first transparent electrode layer;
a second transparent electrode layer laminated on the first transparent electrode layer, and configured to have a different polarity from that of the first transparent electrode layer;
a transparent insulating layer provided between the first transparent electrode layer and the second transparent electrode layer, and configured to insulate the first transparent electrode layer and the second transparent electrode layer from each other; and
an electrochromic module provided on the transparent insulating layer in a specific pattern, and configured to have one or more electrochromic layers being changed to be transparent or opaque by an electric signal applied between the first transparent electrode layer and the second transparent electrode layer,
wherein the vision aid device further includes a lens part including a first lens and a second lens, which are joined to each other while the electrochromic module being interposed therebetween, and
wherein the electrochromic layer is discolored to be opaque when the electric signal is applied between the first transparent electrode layer and the second transparent electrode layer of the electrochromic module whereby a transmittance of an external image and a reflectivity of a specific image are adjusted relatively.

2. The vision aid device of claim 1, wherein the transmittance and the reflectivity are adjusted relatively depending on a disposition shape of the specific pattern.

3. The vision aid device of claim 1, wherein the first lens and the second lens are coupled to each other to be convexo-concave by forming recesses and protrusions having inclined surfaces, on facing surfaces thereof, and
wherein the electrochromic module is disposed on the inclined surfaces of any one of the first lens and the second lens.

4. The vision aid device of claim 3, wherein the inclined surfaces of the first lens and the second lens are formed to be inclined with respect to a projection angle of the specific image projected to the electrochromic layer.

5. The vision aid device of claim 1, further comprising:
an adjustment part configured to adjust a supply amount of the electric signal,
wherein the adjustment part is configured to:
adjust the transmittance and the reflectivity depending on an intensity of the electric signal.

6. A vision aid device based on an electrochromic layer, the vision aid device comprising:
a first transparent electrode layer;
a second transparent electrode layer laminated on the first transparent electrode layer, and configured to have a different polarity from that of the first transparent electrode layer;
an electrochromic layer provided between the first transparent electrode layer and the second transparent electrode layer, and configured to be changed to be transparent or opaque by an electric signal applied between the first transparent electrode layer and the second transparent electrode layer; and
an electrochromic module provided on an outer surface of any one of the first transparent electrode layer and the second transparent electrode layer, and including a reflection part configured to shield light input from an outside and configured to reflect a specific image projected to the electrochromic layer to an outer surface of the other of the first transparent electrode layer and the second transparent electrode layer,
wherein the vision aid device further includes a first lens and a second lens joined to each other while the electrochromic module being interposed therebetween.

7. The vision aid device of claim 6, wherein the first lens and the second lens are coupled to each other to be convexo-concave by forming recesses and protrusions having inclined surfaces, on facing surfaces thereof, and
wherein the electrochromic module is disposed on the inclined surfaces of any one of the first lens and the second lens.

8. The vision aid device of claim 7, wherein the inclined surfaces of the first lens and the second lens are formed to be inclined with respect to a projection angle of the specific image projected to the electrochromic layer.

9. Vision aid glasses comprising:
the vision aid device based on an electrochromic layer of claim 1;
glasses, in which a vision aid device based on an electrochromic layer is provided in one area of each thereof, and configured to protect the eyes of a wearer; and
a frame supporting the glasses and having leg parts spanning the ears of the wearer.

10. The vision aid glasses of claim 9, further comprising:
a camera module configured to photograph a surrounding of the wearer in a specific image; and
a control module configured to transmit the specific image of the camera, which received from the camera, to the electrochromic module,
wherein the control module is configured to:
read a vision loss area of the wearer, select, among specific images received from the camera module, a specific image corresponding to the vision loss area of the wearer, and transmit the selected specific image to the electrochromic module.
